(19) United States
(12) Patent Application Publication
(10) Pub. No.: US 2008/0276871 A1
(43) Pub. Date: Nov. 13, 2008

(54) Connection between a toat rubber and a milking cup sleeve

(76) Inventors: Markus Auburger, Lippstadt (DE); Reinhard Frenser, Rheda-Wiedenbruck (DE); Thomas Rohring, Dortmund (DE); Michael Berentzen, Soest (DE); Martin Neumann, Oelde (DE); Thomas Gruter, Lippstadt (DE); Michael Austermann, Ascheberg (DE)

Correspondence Address: SMITH LAW OFFICE, 8000 EXCELSIOR DRIVE, SUITE 301, MADISON, WI, 53717, US

(21) Appl. No.: 12/151,687

(22) Filed: May 8, 2008

(30) Foreign Application Priority Data
May 11, 2007 (DE) 102007022800.9-23

(51) Int. Cl. A01J 5/08

(52) U.S. Cl. 119/14.49; 119/14.47; 119/14.51

(57) ABSTRACT

The subject matter of the invention relates to a milking cup having a milking cup sleeve in which a teat rubber is arranged.

### FIELD AND BACKGROUND OF THE INVENTION

The subject matter of the invention relates to a milking cup.

Milking cups are used for the machine-milking of animals. The milking cup has a milking cup sleeve in which a teat rubber is arranged. A teat rubber (also referred to as a liner) may have different configurations. For example, U.S. Pat. No. 5,007,378 discloses a teat rubber for use on a milking cup, having a head part which is provided with a sealing lip that forms an insertion opening for the teat. The head part is connected to a shaft part.

In the majority of known configurations of a teat rubber, the latter is integrally formed. With regard to the fact that the shaft part of the teat rubber is brought to bear against the teat, it is expedient for the shaft part to be made of a flexible material. In addition, it is necessary for the teat rubber to be able to be easily cleaned and, in particular, for it to be compatible with milk.

The teat rubber forms, together with the milking cup sleeve, a chamber to which a corresponding vacuum is applied. For this purpose, it is necessary for the space between the teat rubber and the milking cup sleeve to be sealed in an airtight manner. U.S. Pat. No. 5,007,378 discloses a connecting element which is inserted into the end region of the teat rubber such that the teat rubber is spread and the lateral surface of the end region of the teat rubber is brought to bear against an edge of an opening in the milking cup sleeve, with the result that an airtight connection is established between the end region of the teat rubber and the milking cup sleeve. A milk hose can be connected to the connecting element.

Milking cups in which the teat rubber and the milk hose are in the form of an integral unit are also known. Such a unit is assembled in such a manner that the milk hose is passed through the milking cup sleeve, the force needed for assembly for the airtight connection between the teat rubber and the milking cup being able to be applied via the milk hose.

The assembly of a milking cup of the generic type, as described in U.S. Pat. No. 5,007,378, is considerably more complicated. With regard to the fact that a teat rubber is also subject to wear, it is necessary to replace it, which is associated with a considerable amount of force and time.

### SUMMARY OF THE INVENTION

On the basis of this, the present invention is based on the objective of specifying a milking cup which can be assembled in a simpler manner.

The inventive milking cup has a milking cup sleeve and a teat rubber which is arranged in the milking cup sleeve. The teat rubber has a head and an end region opposite the head. A connecting element is connected to the end region. The connecting element is releasably connected to the milking cup sleeve.

This inventive configuration of the milking cup results in simplified assembly and dismantling of the teat rubber. This also simplifies the ability to replace the teat rubber, with the result that the teat rubber can also be replaced by untrained personnel.

One configuration of the inventive milking cup, in which the connecting element is connected to the milking cup sleeve in a form-fitting manner, is particularly preferred. For this purpose, the connecting element and/or the milking cup has/have corresponding means which can be used to achieve the form-fit between the connecting element and the milking cup sleeve. The means may be corresponding projections and cutouts having contours which are matched to one another. The projections and the cutouts may be provided on the connecting element and/or the milking cup sleeve.

Additionally or alternatively, the connection may be force-fitting, with the result that unintentional release of the connecting element from the milking cup sleeve is avoided.

Yet another advantageous configuration of the inventive milking cup proposes that the connecting element be connected to the milking cup sleeve by means of a latching connection.

Yet another advantageous configuration of the inventive milking cup proposes that the connecting element have at least two resilient webs which extend in the axial direction and are connected to the milking cup sleeve. The resilient webs automatically engage in the connecting position when they have assumed a predefined position relative to the milking cup sleeve. One configuration in which the web has a projection which bears against an edge region of the milking cup sleeve is particularly preferred in this case. In this case, the milking cup sleeve preferably has a diameter which is smaller than the distance between the two webs, with the result that the latter are passed through the milking cup sleeve during assembly of the teat rubber and are then pressed together in the end region of the milking cup sleeve, said webs being able to correspondingly spring back after emerging from the milking cup sleeve.

The webs are preferably arranged diametrically. If more than two webs are provided, it is particularly preferred for them to be formed in an equidistant manner with respect to one another when considered in the circumferential direction.

Yet another inventive concept proposes a milking cup comprising a milking cup sleeve, a teat rubber which is arranged in the milking cup sleeve and has a head and an end region opposite the head, and a connecting element which connects a milk hose to the teat rubber, the milk hose having at least one means which is used to secure the teat rubber in the milking cup sleeve.

This inventive configuration of the milking cup simplifies assembly of the milking cup, in particular. It is possible to form the teat rubber with the connecting element and the milk hose with the connecting element in a structural unit, the head of the milk hose then being pulled through the end region of the milking cup sleeve until the teat rubber is secured in the milking cup sleeve using the means.

One configuration in which the milk hose has at least one collar which extends in the circumferential direction and can preferably be brought to bear against an end face of the milking cup sleeve is preferred. This measure makes it possible to visually check whether the teat rubber was properly secured in the milking cup sleeve. In addition, dismantling of the milking cup is simplified.

It is also possible for corresponding cutouts, in which the means of the milk hose engage, to be provided on the inner lateral surface of the end region of the milking cup sleeve, for example. The milk hose can be connected to the milking cup sleeve in a form-fitting and/or force-fitting manner.

If the milk hose has a collar which is formed essentially in the circumferential direction of the milk hose, said collar preferably has an essentially triangular cross section, one face of the collar forming an insertion chamfer.

In order to simplify assembly of the teat rubber in the milking cup sleeve even further, it is proposed that the connecting element have at least one tool engagement region so that a connection to the connecting element can be established using a corresponding tool, with the result that said connecting element can be moved into a position in which it is connected to the milking cup sleeve by applying a tensile force.

Yet another advantageous configuration of the milking cup proposes that the end region of the teat rubber bear against the inner lateral surface of the milking cup sleeve. This results in a fluid-tight connection between the end region of the teat rubber and the milking cup sleeve.

The connecting element is preferably connected to the teat rubber at least in a form-fitting manner. Additionally or alternatively, the connecting element may also be connected to the teat rubber in a force-fitting manner.

In order to connect the teat rubber to the connecting element, it is proposed that the connecting element have a section of essentially mushroom-like design. The teat rubber has a correspondingly configured receptacle. The configurations of the teat rubber and of the connecting element are selected in such a manner that the connection remains during assembly and also during operation as a result of the tensile force of the teat rubber on the connection.

Yet another advantageous configuration of the milking cup proposes that the external diameter of the end region of the teat rubber, when the latter is connected to the connecting element, be greater than the external diameter of the end region of the teat rubber when it is not connected. This widens the end region of the teat rubber, thus advantageously improving the fluid-tight connection between the teat rubber and the milking cup sleeve.

In order to improve the fluid-tight connection between the teat rubber and the milking cup sleeve even further, it is proposed that the milking cup sleeve have a tapering end region.

In order to connect the head of the teat rubber to the milking cup sleeve in a fluid-tight manner, it is proposed that the milking cup sleeve have at least one bulge which engages in a correspondingly designed retaining edge of the head.

The connecting element is preferably produced from a thermoplastic material. The connecting element spreads the clamping geometry of the teat rubber. As a result of the fact that the teat rubber and the connecting element are preferably connected by means of mushroom-like configurations of the connecting element, the connection is also stable when the prestressing force of the teat rubber acts on it. The connecting element is preferably formed from a thermoplastic which is harmless to foodstuffs.

In order to simplify assembly, it is also proposed that the components—the milking cup sleeve, the teat rubber and the connecting element—can only be connected in predefined positions with respect to one another using corresponding recesses or projections. This also results in a rotationally secure connection between the components, in particular between the teat rubber and the connecting element.

The connecting element preferably has a lower section which can be connected to a short milk hose, for example. The short milk hose can be connected to the connecting element if the latter is already connected to the teat rubber, with the result that the teat rubber, the connecting element and the short milk hose form a structural unit. This makes it possible to simplify assembly since the teat rubber can be assembled in the milking cup sleeve by means of a tensile force on the milk hose.

The milking cup sleeve is preferably formed from a metal material, in particular from a stainless steel. It is also possible to form the milking cup sleeve from a plastic, in particular a thermoplastic. With regard to the fact that the milking cup is intended to be used on different animals, it is also possible to equip the milking cup sleeve, in particular, with additional weights which advantageously make it possible to vary the total weight of the milking cup.

Further details and advantages of the invention are explained using the exemplary embodiment illustrated in the drawing without restricting the subject matter of the invention to this specific exemplary embodiment.

### BRIEF DESCRIPTION OF THE DRAWINGS

FIG. 1: schematically shows a perspective view of an upper section of a milking cup sleeve,

FIG. 2: shows the upper section of the milking cup sleeve according to FIG. 1 in conjunction with a teat rubber head,

FIG. 3: shows, in section, the arrangement of the teat rubber in the milking cup sleeve in the lower region of the milking cup,

FIG. 4: shows a connecting element,

FIG. 5: shows, in section, the connection between a lower end of the teat rubber and the connecting element according to FIG. 4,

FIG. 6: shows a sectional illustration of an end region of the milking cup with the teat rubber, the connecting element and the short milk hose as well as the milking cup sleeve, and

FIG. 7: shows a sectional illustration of an end region of the milking cup with the teat rubber, the connecting element and the short milk hose as well as the milking cup sleeve.

### DETAILED DESCRIPTION OF THE PREFERRED EMBODIMENTS

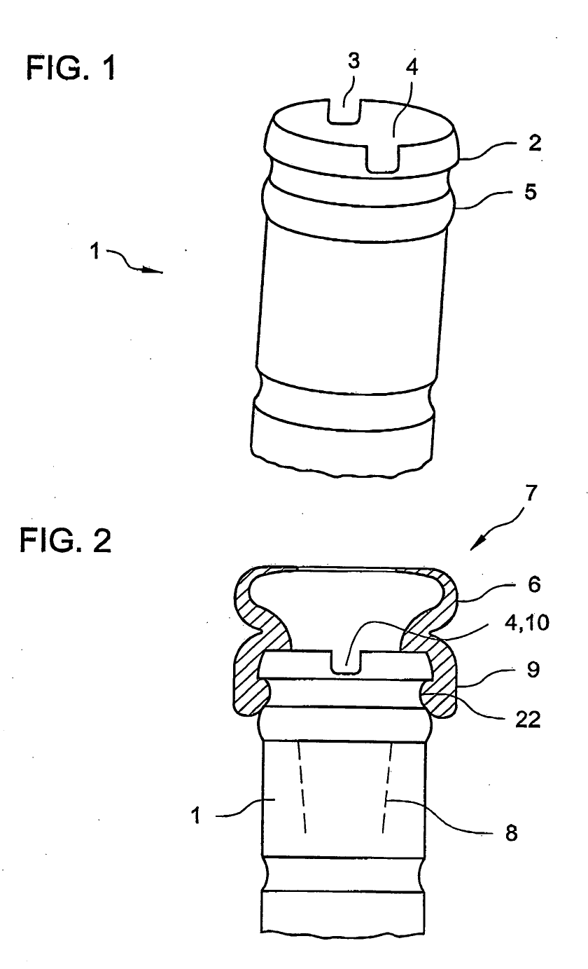

FIG. 1 schematically illustrates a perspective view of an upper region of a milking cup sleeve 1. The milking cup sleeve 1 is essentially cylindrical. It has a circumferential bulge 2 at its upper free end. The bulge 2 tapers towards the free end of the milking cup sleeve 1, with the result that the latter has an essentially frustoconical contour. It can be seen from the illustration in FIG. 1 that recesses 3, 4 are provided in the bulge 2 from the end side of the milking cup sleeve in the direction of the opposite end. The recesses 3, 4 are formed diametrically opposite one another in the exemplary embodiment illustrated. The functionality of the recesses is discussed separately below.

A circumferential collar 5 is provided at a distance from the bulge 2.

The bulge 2 and the circumferential collar 5 together form a groove which has an essentially trapezoidal cross section and in which a corresponding projection 22, which is formed on the retaining edge 9, engages, thus establishing an essentially fluid-tight connection between the retaining edge 9 of the head 6 and the upper region of the milking cup sleeve 1.

FIG. 2 shows the upper region of the milking cup sleeve in conjunction with a head 6 of a teat rubber 7. The head 6 of the teat rubber 7 is connected to a shaft 8 which is illustrated using dashed lines and is arranged in the milking cup sleeve 1. A retaining edge 9 is provided under the head 6. The retaining edge 9 bears against the outer face of the milking cup sleeve 1 and secures the teat rubber to the milking cup sleeve 1. The retaining edge 9 is configured in such a manner that it has a corresponding contour which engages around the bulge 2. The collar 5 results in a delimitation which prevents the teat rubber 7 from being inserted too far into the milking cup sleeve 1.

The teat rubber 7 is introduced into the milking cup sleeve 1 in a particular orientation. For this purpose, the teat rubber 7 has corresponding projections 10 which engage in the recesses 3, 4, with the result that a defined assembly position of the teat rubber 7 is predefined.

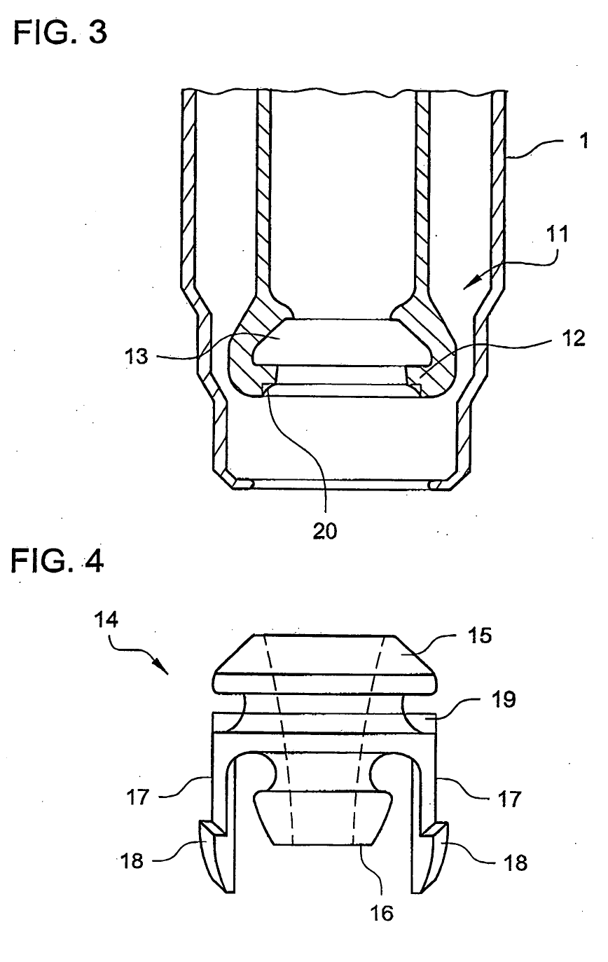

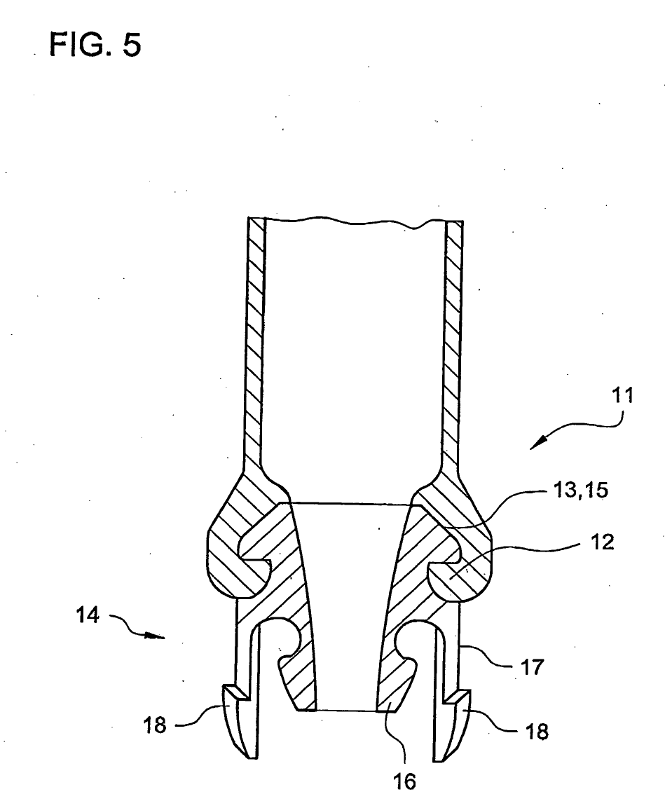

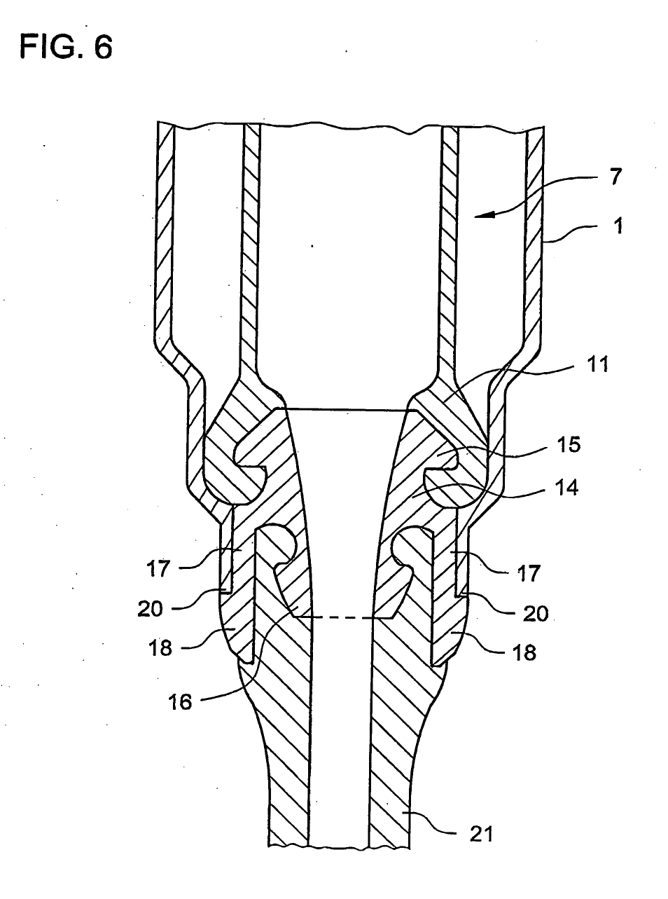

The position of the teat rubber 7 in the milking cup sleeve 1 is illustrated in FIG. 3. It can be seen from FIG. 3 that the end region 11 which is opposite the head 6 has an inner circumferential edge 12 which reduces the clear cross section of the shaft 8. When considered in the direction of the head 6, the end region 11 has an essentially conical receptacle 13.

FIG. 4 shows a connecting element 14. The connecting element 14 has a first section 15 of mushroom-like design. The section 15 has a contour which is matched to the end region 11 of the teat rubber. The other end of the connecting element 14 has a second section 16 of mushroom-like design. It can be seen from FIG. 4 that two opposite webs 17 are provided at a distance from the section 16 in the longitudinal direction of the connecting element 14. The webs 17 are resilient. They have respective projections 18 at their free ends.

The connecting element 14 is connected to the end region 11 of the teat rubber. In this case, the section 15 of mushroom-like design engages in the receptacle 13, with the result that a form-fitting and force-fitting connection is established between the connecting element 14 and the teat rubber.

The connecting element 14 may be equipped with positioning elements 19, as can be seen from FIG. 4. The positioning elements 19 engage in corresponding recesses 20 in the end region 11 of the teat rubber when the connecting element 14 is connected to the teat rubber 7, thus achieving a defined installation position of the connecting element 14 with respect to the teat rubber 7.

The section 16 of the connecting element 14 is designed in such a manner that it is suitable and intended for connection to a milk hose.

In order to form a milking cup, the connecting element 14 is first of all connected to the teat rubber 7. The teat rubber 7 is inserted into the milking cup sleeve 1. The teat rubber 7 is pressed into the milking cup sleeve until the connection between the head 6 of the teat rubber and the upper region of the milking cup sleeve is produced.

The connecting element 14 which is connected to the teat rubber 7 is pulled out of the milking cup sleeve 1 until the projections 18 engage behind the lower edge 20. The clear width of the milking cup sleeve 1 is preferably selected in such a manner that the webs 17 are pressed together during assembly and then spring back when the projections 18 protrude from the milking cup sleeve. The webs 17 may be formed with corresponding tool engagement regions, with the result that the webs 17 can be pulled out of the milking cup sleeve using tools (not illustrated) which engage in the tool engagement regions (not illustrated).

A milk hose 21 can then be connected to the connecting element 14.

This configuration of the milking cup results in simplified assembly of the milking cup.

A configuration of the end region 11 and of the upper section 15 of the connecting element 14 such that, when the connecting element 14 is connected to the end region 11 of the teat rubber, said end region is widened, that is to say its outer cross section is enlarged, is advantageous. If the connecting element 14 is secured to the milking cup sleeve, the lateral surface of the end region 11 comes to bear against an inner region of the milking cup sleeve, this bearing arrangement being such that a preferably fluid-tight connection is established between the end region 11 and the milking cup sleeve 1.

In order to avoid torsional forces being introduced into the teat rubber during use of the milking cup sleeve, the end region of the milking cup sleeve preferably has corresponding cutouts into which the projections 18 at least partially project, thus defining the position of the connecting element 14 with respect to the milking cup sleeve 1.

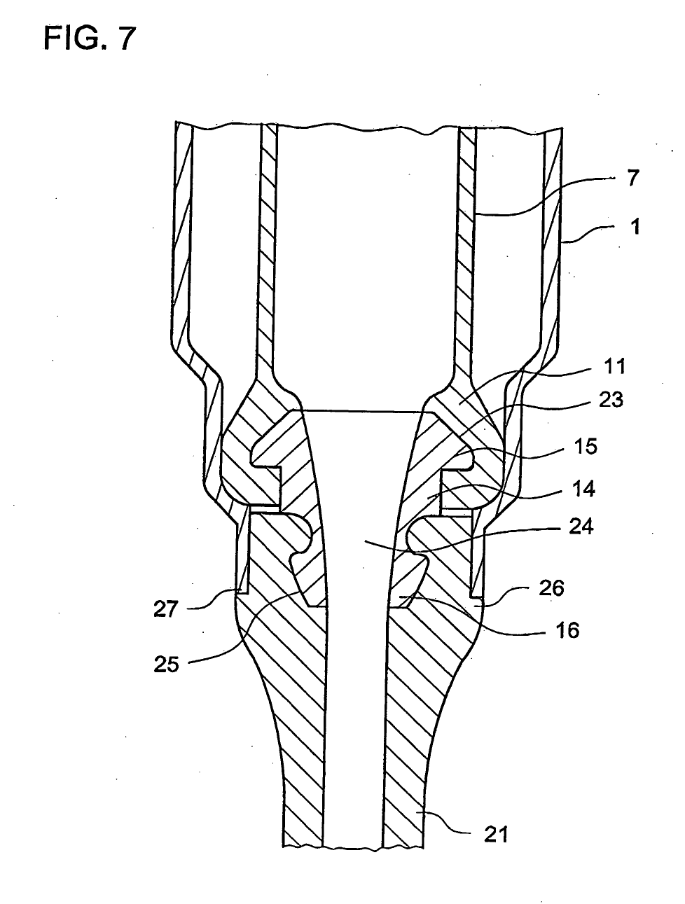

FIG. 7 illustrates a second exemplary embodiment of a milking cup. In this case, FIG. 7 shows the lower region of the milking cup in section.

The milking cup has a milking cup sleeve 1. A teat rubber 7 is arranged inside the milking cup sleeve. The teat rubber 7 has an end region 11. A connecting element 14 is connected to the end region 11 of the teat rubber 7. The connecting element 14 has a section 15 which is essentially like the head of a mushroom and projects into a correspondingly configured receptacle 23 of the end region 11 of the teat rubber 7. The connection between the teat rubber 7 and the connecting element 14 is fluid-tight, with the result that milk can flow away from the teat rubber through the channel 24 formed in the connecting element 14. The outer lateral surface of the end region 11 bears against the inner lateral surface of the milking cup 1. There is a fluid-tight connection between the end region 11 and the milking cup sleeve 1, with the result that no air or liquid can penetrate the milking cup interspace, that is to say the space between the teat rubber and the milking cup sleeve, in an undesirable manner.

The connecting element 14 has a section 16 of mushroom-like design. The section 16 of mushroom-like design engages in a correspondingly designed receptacle 25 in the end section of the milk hose 21. The connection between the milk hose 21 and the connecting element 14 is preferably fluid-tight.

The milk hose 21 has a circumferential collar 26 which bears against the end face 27 of the milking cup sleeve 1. The connection between the milk hose 21 and the milking cup sleeve 1 is fluid-tight, in particular.

Additionally or alternatively, the milking cup sleeve 1 and/or the milk hose 21 may have a plurality of projections or receptacles which are directed radially inwards or radially outwards and the contours of which are designed to correspond, with the result that a form-fitting and/or force-fitting connection can be established between the milk hose 21 and the milking cup sleeve 1.

In order to form the milking cup, the teat rubber 7, the connecting element 14 and the milk hose 21 are connected to one another to form a structural unit. The milk hose 21 is pulled through the milking cup sleeve. The head of the teat rubber is secured to the upper end region of the milking cup sleeve by means of the retaining edge 9. The milk hose is pulled out of the milking cup sleeve 1, by applying a tensile force, until the collar 26 bears against the end face of the milking cup sleeve 1.

The milking cup can be assembled without additional tools.

Different prestresses can be introduced into the teat rubber 7 on the basis of the configuration of the connecting element 14. In addition, the radial force between the end region 11 of the teat rubber and the milking cup sleeve can be varied.

It is not compulsory for the connection between the milk hose 21 and the milking cup sleeve 1 to be fluid-tight. It is sufficient if the connection between the milk hose 21 and the connecting element 14 is fluid-tight. As a result of the embodiment illustrated, less force needs to be applied to change the teat rubber and the milk hose. Assembly and dismantling of the milking cup are considerably simplified by the invention.

1. A milking cup comprising:
a milking cup sleeve;
a teat rubber disposed at least partially in the milking cup sleeve,
and the teat rubber includes an end region; and
a connecting element releasably joined to the teat rubber end region.

2. The milking cup according to claim 1, wherein the connecting element is connected to the milking cup sleeve end region in a form-fitting manner.

3. The milking cup according to claim 1, wherein the connecting element comprises a resilient section releasably joined to the end region.

4. The milking cup according to claim 1, wherein the connecting element comprises a plurality of resilient webs extending in an axial direction and in contact with the milking cup sleeve.

5. The milking cup according to claim 4, wherein the web comprises a projection bearing against an edge region of the milking cup sleeve.

6. A milking cup comprising:
a milking cup sleeve;
a teat rubber disposed at least partially in the milking cup sleeve;
a connecting element releasably joined to the teat rubber; and
a milk hose releasably joined to the connecting element.

7. The milking cup according to claim 6, wherein the milk hose comprises a collar bearing against an edge region of the milking cup sleeve.

8. The milking cup according to claim 7, wherein the collar has an essentially triangular cross section.

9. The milking cup according to claim 1, wherein the end region of the teat rubber bears against an inner lateral surface of the milking cup sleeve.

10. The milking cup according to claim 1, wherein the connecting element is releasably joined to the teat rubber in a form-fitting manner.

11. The milking cup according to claim 11, wherein the connecting element comprises a section of essentially mushroom-like shape and the teat rubber comprises a correspondingly configured receptacle.

12. The milking cup according to claim 11, wherein an external diameter of the end region of the teat rubber expands when releasably joined to the connecting element.

13. The milking cup according to claim 1, wherein the milking cup sleeve comprises a tapering end region.

14. The milking cup according to claim 1, wherein the milking cup sleeve comprises a bulge engaging a correspondingly shaped retaining edge of the head.

15. A milk conduit for being releasably joined to a milking cup sleeve, the milk conduit comprising:
a teat rubber having an end region;
a connecting element releasably joined to the teat rubber end region; and
a milk hose releasably joined to the connecting element.

16. The milk conduit of claim 15, wherein the teat rubber end region defines a receptacle and the connecting element defines an upper section disposed in the receptacle.

17. The milk conduit of claim 15, wherein the teat rubber end region expands when releasably joined to the connecting element.

18. The milk conduit of claim 15, wherein the milk hose defines a collar.

19. The milk conduit of claim 15, wherein the connecting element comprises projections that move substantially radially outwardly when the connecting element is releasably joined to the milk hose.

20. The milk conduit of claim 15, wherein the milk hose defines an upper region that expands when releasably joined to the connecting element.
